(19) United States
(12) Patent Application Publication
(10) Pub. No.: US 2002/0094381 A1
(43) Pub. Date: Jul. 18, 2002

(54) Camouflage coating kit and method

(75) Inventors: Todd R. Niemuth, Oostburg, WI (US); Brian E. Woodnorth, Whitefish Bay, WI (US); Craig S. Serio, New Berlin, WI (US)

Correspondence Address: FOLEY & LARDNER, 777 EAST WISCONSIN AVENUE, MILWAUKEE, WI, 53202, US

(73) Assignee: Newell Operating Company

(21) Appl. No.: 10/042,633

(22) Filed: Jan. 9, 2002

Related U.S. Application Data
(60) Provisional application No. 60/260,485, filed on Jan. 9, 2001.

(51) Int. Cl. B05D 1/36; B05D 5/00; B05D 1/28

(52) U.S. Cl. 427/256; 427/407.1; 427/261; 427/428; 118/258

(57) ABSTRACT

A camouflage applicating kit and method are provided. The kit includes a paint tray, a roller frame having a roller cover supporting portion, a plurality of pattern camouflage roller covers configured to be interchangeably rotatably supported by the roller frame, and an instruction media described in one or more techniques for creating a multi-colored camouflage pattern upon an article. The instruction media describes a method which includes applying a first colored paint to a first patterned paint applicator medium carried by a paint roller, rolling the medium along a surface of an article with a plurality of substantially non-overlapping strokes, applying a second colored paint to a second patterned paint applicator medium carried by a paint roller, and rolling the second medium along the surface over the first colored pattern coating of paint with a plurality of substantially non-overlapping strokes.

### CROSS-REFERENCE TO RELATED PATENT APPLICATIONS

The present application claims priority under 35 U.S.C. § 119(e) from U.S. Provisional Patent Application Serial 60/260,485 entitled CAMOUFLAGE COATING KIT AND METHOD, filed on Jan. 9, 2001 by Todd R. Niemuth, Brian E. Woodnorth and Craig S. Serio, the full disclosure of which in its entirety is hereby incorporated by reference.

### FIELD OF THE INVENTION

The present invention relates to kits and methods for providing boats, hunting blinds, and other accessories with a camouflaged appearance. In particular, the present invention relates to a painting kit and method for providing such a camouflage appearance.

### BACKGROUND OF THE INVENTION

Camouflage generally consists of one or more colors placed on an article such that the article blends in with the surrounding environment to make the article indistinguishable from the surrounding environment. Such camouflage typically requires distinct, sharp borders between the different colors of the combination. Such camouflage is typically used in hunting applications, military applications or wildlife observing applications. The combination of colors used for camouflage varies depending upon the intended surrounding environment. For example, the colors of the camouflage will vary depending upon whether the camouflage is intended to be used in a brown or tan desert environment, a predominantly green jungle, a summer woodland environment, a predominantly brown and orange autumn woodland environment, or a green and brown marsh grass environment.

Camouflage is typically applied to articles by stencil kits or by preprinted camouflage tape. Stencil kits typically include one or more sheets stenciled or provided with openings which are to be laid over the article to be camouflaged. After applying the sheets over the article, the user typically sprays paint onto the sheets creating the camouflaged pattern on the article. Creating camouflage upon articles using such stencil kits requires great skill, is extremely expensive and is extremely time consuming.

Camouflage is also typically applied to articles using camouflage tape. Such tape generally consists of rolls or sheets of material having adhesive on a first side and having a preprinted camouflage pattern on a second opposite side. The sheets or rolls of tape are adhered to the article in desired locations. Similar to the stencil method, applying camouflage to an article using sheets or rolls of preprinted camouflage tape can be tedious, time consuming and extremely expensive.

Thus, there is a continuing need for a kit and method which allows for the cost efficient and time efficient application of camouflage to various articles.

### SUMMARY OF THE INVENTION

According to one exemplary embodiment of the present invention, a camouflage applicating kit for applying a camouflage pattern to an article includes a paint tray, a roller frame having a roller cover supporting portion, a plurality of patterned camouflage roller covers, and an instruction media. Each camouflage roller cover has at least one raised portion and at least one depressed portion. The plurality of patterned camouflage roller covers are configured to be interchangeably rotatably supported by the roller frame. The instruction media describes one or more techniques for creating a multi-colored camouflage pattern upon an article.

According to another exemplary embodiment, a method for applying a multi-color camouflage pattern to an article is provided. The method includes the steps of applying a first colored paint to a first patterned paint application medium carried by a paint roller, positioning the first patterned paint application medium against a surface of the article and rolling the first paint application medium along the surface with a plurality of substantially non-overlapping first strokes to apply a first colored pattern coating of paint on the surface, applying a second colored paint to second patterned paint application medium carried by a paint roller and positioning the second patterned paint application medium against the surface of the article and rolling the second paint application medium along the surface over the first colored patterned coating of paint with a plurality of substantially non-overlapping second strokes to apply a second colored patterned coating of paint over the first colored patterned coating of paint.

According to yet another exemplary embodiment, a method for applying a camouflage to a surface of an article includes the steps of providing a split tray containing a first colored paint in a first portion and a second colored paint in a second portion, applying the first colored paint and the second colored paint to a first patterned paint application medium and a second patterned paint application medium, respectively, carried by a single paint roller, positioning the first patterned paint application medium and the second patterned paint application medium against a surface of the article and rolling the first paint application medium and the second paint application medium along the surface with a plurality of substantially non-overlapping strokes to apply a first colored patterned coating of paint and a second colored patterned coating of paint on the surface in a side-by-side relationship, and positioning the paint roller and the first patterned paint application medium and the second patterned paint application medium against the surface and rolling the first patterned paint application medium and the second patterned paint application medium over the surface such that the first patterned paint application medium applies the first colored patterned coating of paint over the previously applied second colored patterned coating of paint and such that the second patterned paint application medium applies the second colored patterned coating of paint over the previously applied first colored patterned coating of paint.

According to yet another exemplary embodiment, a method for applying camouflage to an article includes the steps of positioning a patterned paint application medium loaded with a first colored paint against a surface of the article and rolling the paint application medium along the surface with a plurality of substantially non-overlapping first strokes to apply a first colored patterned coating of paint on the surface and positioning a patterned paint application medium loaded with a second colored paint against the surface of the article and rolling the paint application medium along the surface over the first colored patterned coating of paint with a plurality of substantially non-overlapping strokes to apply a second colored patterned coating of paint over the first colored patterned coating of paint.

### BRIEF DESCRIPTION OF THE DRAWINGS

FIG. 1 is a perspective view of an exemplary embodiment of a camouflage coating kit of the present invention.

FIG. 2 is a front elevational view illustrating a first step of a method for creating a camouflage pattern on a surface of an article.

FIG. 3 is a front elevational view of a second step of the method for creating a camouflage pattern upon a surface of an article.

FIG. 4 is a front elevational view of a third step of the method for creating a camouflage pattern upon a surface of an article.

FIG. 5 is a front elevational view of a third step of an alternative method for creating a camouflage pattern upon a surface of an article.

FIG. 6 is a perspective view of an alternative embodiment of the camouflage coating kit of FIG. 1.

### DETAILED DESCRIPTION OF THE PREFERRED EMBODIMENTS

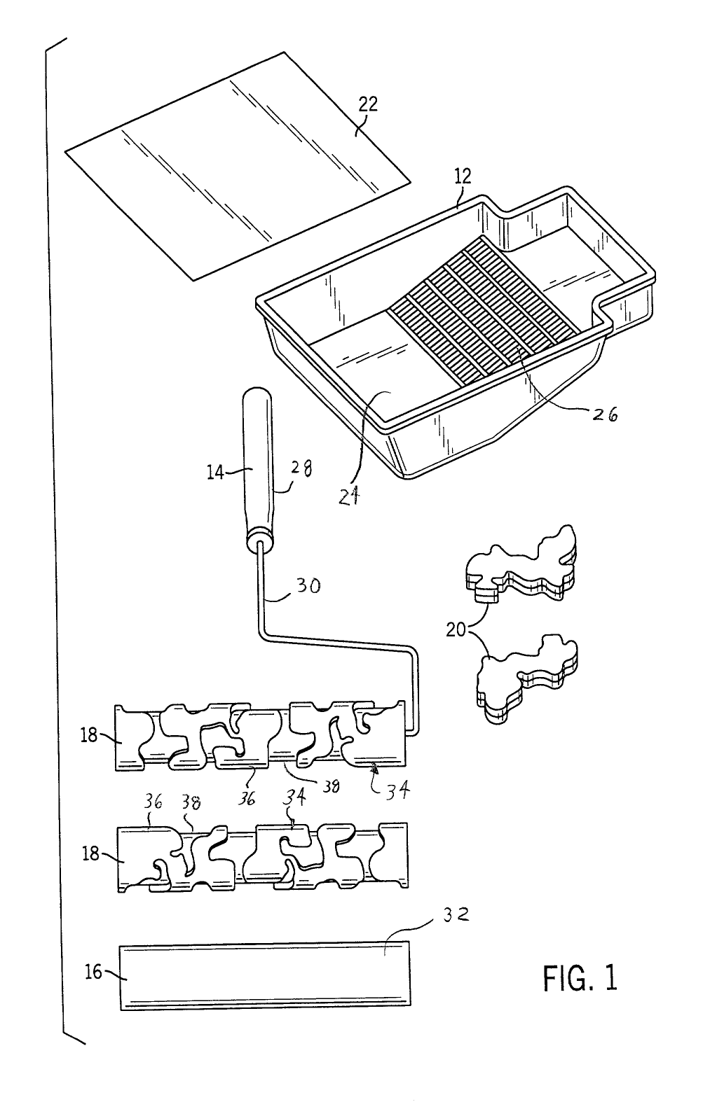

FIG. 1 depicts a camouflage application kit 10. Kit 10 generally includes tray 12, roller frame 14, roller cover 16, a plurality of camouflage roller covers 18, a plurality of camouflage edging tools 20 and an instruction media 22. Tray 12 generally comprises a pan-shaped paint receptacle having a well 24 and a textured ramp 26 extending upward from the well 24. The well 24 contains paint that enables the roller covers 16, 18 to be lowered into the well 24 to be loaded with paint. The ramp 26 provides a surface against which the roller covers 16, 18 may be rolled to evenly coat the paint on the surface of the roller covers 16, 18 and to remove excess paint from the roller covers 16, 18. Although less desirable, other paint containing receptacles may be used to apply paint to the roller covers 16, 18.

Roller frame 14 comprises a conventionally known roller frame having a handle 28, a rod 30 extending from the handle 28, and one or more cages (not shown) rotatably supported about the rod 30. The cages, whether plastic or wire, releasably grip one or more roller covers 16, 18 to rotatably support the one or more roller covers 16, 18 relative to the rod 30 of the frame 14. An exemplary conventionally known roller frame is disclosed in U.S. patent application Ser. No. 5,979,009, the full disclosure of which in its entirety is hereby incorporated by reference.

Roller cover 16 generally comprises a standard or a conventionally known roller cover having an elongate cylindrical core (not shown) carrying a coating or paint applying medium 32 having a continuous unindented or unpatterned outer circumferential surface. In the exemplary embodiment, roller cover 16 has a paint applying medium 32 comprising polyester fabric.

Camouflage roller covers 18 each generally consist of a tubular core (not shown) supporting an indented or patterned outer paint applying medium 34. In the exemplary embodiment, the paint applying medium 34 comprises polyester nap which has been embossed and patterned. The medium 34 has at least one raised portion 36 and at least one depressed portion 38 such that when one of camouflaged roller covers 18 is rolled across a surface, covers 18 apply the paint or coating to the surface in a pattern. Kit 10 generally includes two such camouflage roller covers 18 so that differently colored patterns may be immediately applied to a surface, whether precoated by roller cover 16 with a base coat or whether the base coat is preexisting, without a need to re-use the camouflage roller cover during a particular project. This is extremely advantageous since there is insufficient time to wash and thoroughly dry a single camouflage roller cover between the application of different colored camouflage patterns. Moist or incompletely dried pattern camouflage roller covers tend to create non-distinct, unsharp patterns or coatings. Because kit 10 includes two such camouflage roller covers 18, the camouflage pattern created by kit 10 is superior in quality since a dry camouflage roller cover 18 may be used for application of the second colored pattern.

Camouflage edging tools 20 are provided for applying the two differently colored patterns in a tight areas where camouflage roller covers 18 cannot gain access such as in corners. Edging tools 20 preferably comprise hand-held stamper sponges preferably configured to allow manual application of the different colored patterns. Although less desirable, kit 10 may omit such edging tools while still enabling a general camouflage pattern to be created on an article.

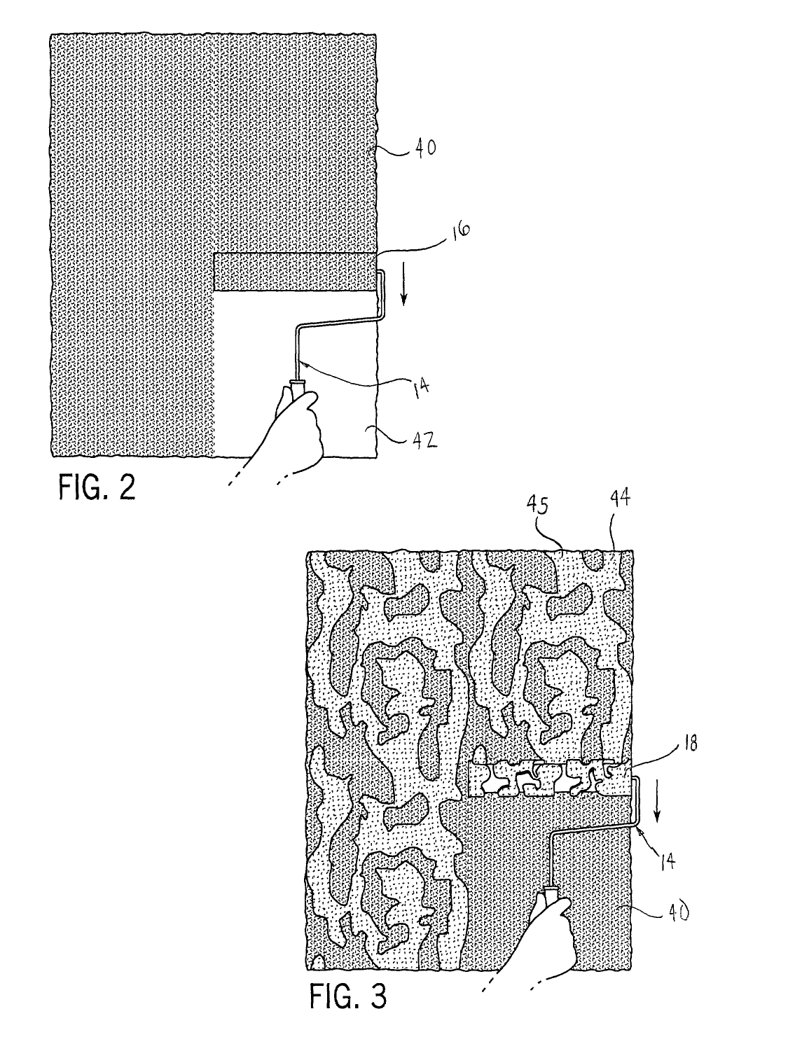

Instructional media 22 preferably comprises an instruction sheet containing directions for creating or applying the camouflage pattern on an article. Alternatively, instruction media 22 may comprise a video, audio tape or other means for conveying the proper technique for creating a camouflage pattern using kit 10. FIGS. 2-4 illustrate one method for applying camouflage to a surface of an article. As shown in FIG. 2, roller frame 14 is first loaded with a base coat of paint 40 and is roller across coat surface 42 with the base coat of paint. Paint coat 40 preferably comprises the darkest color of the overall camouflage pattern. If the article being painted already has a dark base camouflage color, the step depicted in FIG. 2 may be eliminated. Once applied, base coat 40 should be allowed to dry to a slightly tacky touch, usually 20 to 30 minutes for latex paints and slightly longer for oil-based paints.

After base coat 40 has sufficiently dried upon surface 42, roller cover 16 is removed from the cage of paint roller frame 14 and is replaced with a first one of camouflage roller covers 18. Roller cover 18 is then lowered into tray 12 containing a second differently colored paint 44 so as to load roller cover 18 with paint 44. Roller cover 18 should be rolled across the textured ramp 26 of tray 12 to remove excess paint. After roller cover 18 is loaded with paint 44, roller cover 18 is rolled across paint coat 40 and surface 42 as shown in FIG. 3 to create a pattern 45. Roller cover 14 should preferably be applied to surface 42 such that all of the strokes of paint roller frame 14 are in the same direction with little or no overlap between such strokes and between the pattern of paint 44 created upon base layer 40 and surface 42. This process is continued until the full surface area of the article to be provided with the camouflage pattern has been coated with paint 44. Paint 44 preferably comprises the lightest color of the overall camouflage pattern. To place paint coat 44 in corners or tight areas, trim tools 20 (shown in FIG. 1) are loaded wit paint 44 from tray 12 and are stamped or applied to base coat 40 and surface 42. Once the application of paint 44 to the articles being completed, paint coat 44 should preferably be allowed to sufficiently dry to a slightly tacky touch.

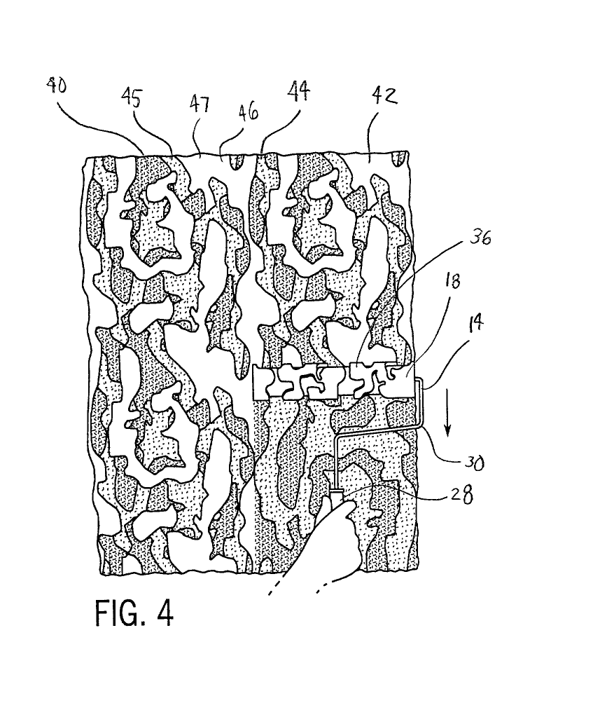

FIG. 4 illustrates the third step for applying a multi-color camouflage pattern. In particular, after the paint coat 44 has sufficiently dried to a slight tacky touch, the first camouflage roller cover 18 is removed and replaced with the second camouflage roller cover 18. The second camouflage roller cover 18 is then lowered into tray 12 and rolled across ramp 26 to load the second roller cover 18 with paint and to remove any excess paint from medium 34. Once loaded with paint 46, the second camouflage roller cover 18 is rolled over top of the first pattern 45 of paint 44 and over top of base coat 40 to create a second camouflage pattern 47 of paint coat 46 on top of the first pattern 45. Once again, paint roller frame 14 and the second camouflage roller cover 18 should be rolled across the surface being painted in the same direction with little or no overlap between strokes. This process should be continued until the entire surface being camouflaged is applied with pattern 47. For tight areas and corners, the second trim tool 20 should be loaded with paint to be loaded with paint 46 from tray 12 and stamped or applied to surface 42 over base coat 40 and over pattern 45 of paint 44. The raised portions 36 and depressed portions 38 of medium 34 are arranged in substantially identical patterns on roller covers 18. Alternatively, roller covers 18 may be provided with distinct patterns of raised portions 36 and depressed portions 38.

According to one preferred embodiment, paint 44 and paint 46 have colors selected from green, tan, olive, brown, gray, beige, black and the like. In one particular embodiment, base coat 40 is black, paint 44 is tan, and paint 46 is olive. Various combinations of colors may be employed depending upon the environment in which the article is to be used. Moreover, although less desirable, the above-described method may be employed using kits or systems other than kit 10. For example, for those using a roller having a cage and removable roller covers, a plurality of paint rollers having permanently mounted roller portions may be utilized. Instead of using a single paint tray, multiple paint trays containing the different colors may be employed. Furthermore, although less desirable, a single camouflage roller cover may be employed, wherein the roller cover must be cleaned and sufficiently dried prior to being loaded with the second camouflage paint.

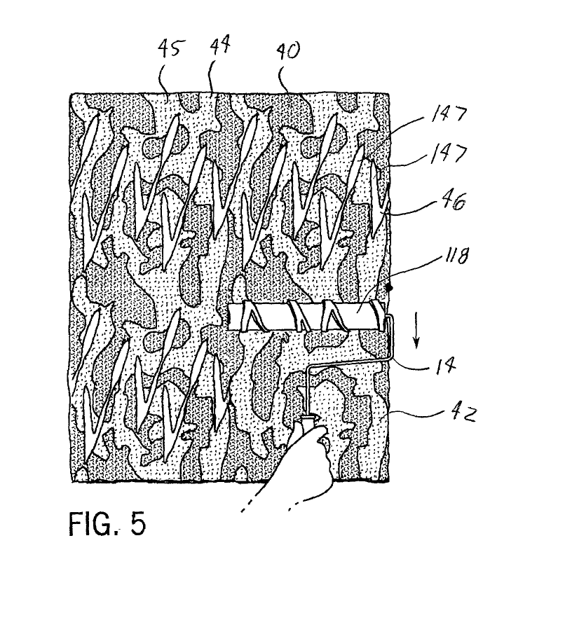

FIG. 5 illustrates an alternative method for applying a multi-color camouflage pattern to a surface of an article. Overall, the method depicted in FIG. 5 is substantially identical to the method depicted and described with respect to FIGS. 2-4, except that in lieu of utilizing a second one of camouflage roller covers 18 to apply a pattern 47 of paint 46, an alternative camouflage roller cover 118 is loaded with paint 46 and rolled across surface 42 over top of base coat 40 and pattern 45 of paint 44 to create a pattern 147 of paint 46. Pattern 147 includes raised portions in the form or shape of a plurality of naturally occurring vegetation shapes such as cattails, grass, leaves, and bark. In the particular embodiments illustrated, roller cover 118 includes a plurality of cattails. Although roller cover 18 is illustrated as including all cattails, roller cover 18 may alternatively include a plurality of different naturally occurring vegetation shapes.

FIG. 5 illustrates pattern 147 being applied to surface 42 with roller frame 14 and roller cover 118 being applied with uni-directional non-overlapping strokes. Alternatively, in contrast to the step depicted in FIG. 4, roller cover 118 and paint roller frame 114 may be manipulated to roll roller cover 118 in an arcing motion and preferably in alternating arc directions to create a natural flared pattern of cattails. Similar motions should be utilized when applying other vegetation shapes such as grass, leaves and bark.

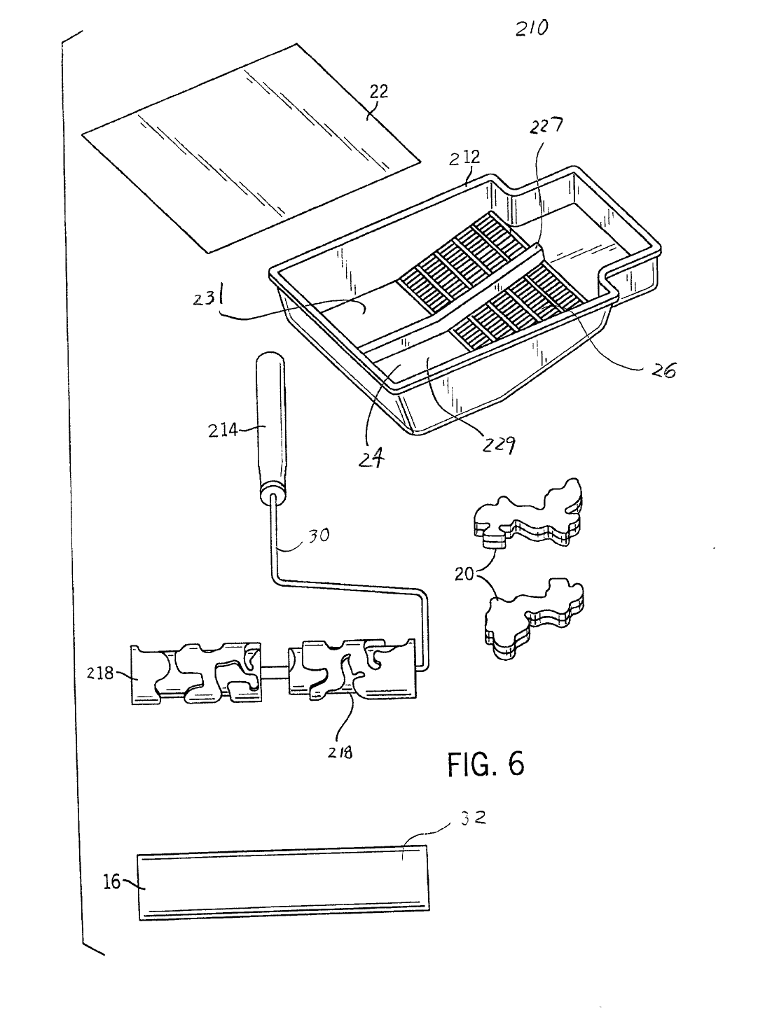

FIG. 6 illustrates kit 210, an alternative embodiment of kit 10. Kit 210 is similar to kit 10 except that kit 210 includes tray 212, roller frame 214, and camouflage roller covers 218 in lieu of tray 212, roller 14, and camouflage roller covers 16, 18, respectively. For ease of illustration, those remaining components of kit 210 which correspond to similar components of kit 10 are numbered similarly. Tray 212 is similar to tray 12 except that tray 212 additionally includes a partitioning wall 227 which divides tray 212 into a first portion 229 for containing a first colored paint and a second portion 231 for containing a second colored paint. Paint roller frame 214 is similar to roller frame 14 except that frame 214 simultaneously rotatably supports two coaxial camouflage roller covers 218. According to one preferred embodiment, roller frame 214 includes a pair of coaxially spaced cages which rotate independently of one another. Due to the general L-shaped configuration of roller frame 214, roller frame 214 is capable of supporting elongate roller cover 16, as well as both camouflage roller covers 218, simultaneously. Camouflage roller covers 218 are substantially identical to camouflage roller covers 18 except that camouflage roller covers 218 have a shorter axial length so as to be capable of being simultaneously rotatably supported by roller frame 214. Although roller covers 218 are illustrated as having the same pattern, roller covers 218 may alternatively have different patterns. Moreover, one or both of roller covers 218 may alternatively include naturally occurring vegetation shapes such as cattails, grass, leaves and bark. The remaining components of kit 210 are substantially identical to kit 10. One example of a split paint tray similar to paint tray 212 and of a split roller frame similar to roller frame 214 is depicted and described in U.S. Pat. No. 5,966,772, the full disclosure of which is hereby incorporated by reference.

Kit 210 facilitates the creation of a camouflage pattern on a surface of article utilizing an alternative method. Similar to the method depicted in FIGS. 2-4, a base coat 40 is initially applied to a surface using paint roller frame 214 and roller cover 16. The color of the base coat 40 should preferably be the darkest color of the multi-color camouflage pattern being created. Alternatively, if the surface already has a dark camouflage color, the application of a base coat may not be necessary.

After the surface of the article, such as a wall, has been provided with a base coat 40, the camouflage pattern is ready to be applied. To do so, roller cover 16 is removed from paint roller frame 214 and both of camouflage roller covers 218 are positioned upon roller frame 214 with each cover 218 positioned upon one of the two cages. A first paint color, such as paint color 44, is poured into one of the tray portions 229, 231 while a second paint color, such as paint color 46, is poured into the other of the portions 229, 231 of tray 212. Once tray 212 is sufficiently filled with the paint colors, the first and second camouflage roller covers 218 are lowered into the first and second portions of the tray and are rolled across ramp 26 to apply colors 44 and 46 to the first and second roller covers 218. Once each of roller covers 218 have been loaded with differently colored paint, roller covers 218 are simultaneously rolled across the surface and across the base coat to create two side-by-side differently colored patterns on the surface of the article. Roller covers 218 and frame 214 should be manipulated such that roller frame 214 is moved across the surface in the same direction with little or no overlap between strokes. This process is continued across substantially the entire surface to which a camouflage pattern is to be applied. Once again, corners and tight spots may have the two paint colors stamped upon them using camouflage edging tools 20.

Once the initial layer of camouflage pattern has been applied to the surface of the article (the layer including alternating coats of two differently colored patterns), a second layer of camouflage pattern is applied by reloading camouflage roller covers 218 with the same colored paint and simply flipping roller frame 214 over 180 degrees and rolling roller covers 218 across the surface of the article such that the first colored paint is applied over the second colored paint and such that the second colored paint is applied over the first colored paint of the first applied layer. This process is continued across substantially the entire area of the surface being camouflaged. As a result, all areas of the surface of the article being camouflaged will have three overlapping colors, the base coat, the first color 44 and the second color 46. Thus, kit 210 enables a multi-color camouflage pattern to be applied to a wall or other surface of an article without the need for switching roller covers to apply different camouflage colors. Because roller frame 14 and the camouflage roller covers are manipulated so to apply paint using strokes which are in the same general direction so as to not substantially overlap one another, the camouflage pattern has distinct sharp borders between different colors of the combination. Although less desirable, such different colors and patterns may be applied using overlapping strokes.

Each of the above described kits and methods relies upon a positive paint impression technique wherein the main pattern being created is the result of paint being applied to raised portions of the roller cover in the shape of the pattern and rolling the roller cover across the surface. Alternatively, the desired pattern may be created using a negative impression technique wherein the pattern is defined by non-paint carrying depressed areas of the paint roller cover such that the raised portions of the paint roller cover carrying the paint define portions surrounding the desired shape. For example, a pattern of green leaves may be provided by the positive method, wherein green paint is applied to raised portions of a paint roller in the shape of green leaves and applied to the surface of the article. Alternatively, the pattern of green leaves may be provided by the negative method over a green base coat, wherein a non-green paint color is applied to the raised portions of the paint roller cover and wherein the recessed embossed portions of the paint roller cover are in the shape of leaves, such that the green base coat is substantially covered but for selected portions which are in the shape of the desired green leaves. Although less desirable, in lieu of applying paint to create the desired pattern, paint rollers 18, 218 may alternatively be used to remove selected portions of wet paint to create the desired pattern.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. A camouflage applicating kit for applying a camouflage pattern to an article, the kit comprising:
a paint tray;
a roller frame having a roller cover supporting portion;
a plurality of patterned camouflage roller covers, wherein each camouflage roller cover has at least one raised portion and at least one depressed portion and wherein the plurality of patterned camouflage roller covers are configured to be interchangeably rotatably supported by the roller frame; and
an instruction media describing one or more techniques for creating a multi-colored camouflage pattern upon an article.

2. The kit of claim 1 further including a roller cover having a uniform unindented outer circumferential surface.

3. The kit of claim 2 including a plurality of camouflage edging tools.

4. The kit of claim 1 including a plurality of camouflage edging tools.

5. The kit of claim 1 wherein each camouflage roller cover has an axial length greater than or equal to an axial length of the roller frame supporting portion such that the roller frame supporting portion supports a single camouflage roller cover.

6. The kit of claim 5, wherein each camouflage roller cover has an axial length of at least about 9 inches.

7. A method for applying a multi-color camouflage pattern to an article, the method comprising:
applying a first colored paint to a first patterned paint application medium carried by a paint roller;
positioning the first patterned paint application medium against a surface of the article and rolling the first paint application medium along the surface with a plurality of substantially non-overlapping first strokes to apply a first colored patterned coating of paint on the surface;
applying a second colored paint to a second patterned paint application medium carried by a paint roller;
positioning the second patterned paint application medium against the surface of the article and rolling the second paint application medium along the surface over the first colored patterned coating of paint with a plurality of substantially non-overlapping second strokes to apply a second colored patterned coating of paint over the first colored patterned coating of paint.

8. The method of claim 7, wherein the plurality of first strokes are each in substantially a same single direction.

9. The method of claim 8, wherein the plurality of second strokes are each in substantially a same single direction.

10. The method of claim 7 including the step of allowing the first colored patterned coating of paint to dry to a slightly tacky touch before rolling the second paint application medium along the surface.

11. The method of claim 7, wherein the second colored paint is darker than the first colored paint.

12. The method of claim 7, wherein the first patterned paint application medium and the second patterned paint application medium have substantially identical patterns.

13. The method of claim 7 including the step of applying the first colored paint with a first hand-held stamper trim tool in constricted areas and corners.

14. The method of claim 13 including the step of applying the second colored paint over the first colored paint with a second hand-held stamper trim tool.

15. The method of claim 7 including the step of removing the first patterned paint application medium from the paint roller after the first colored patterned coating of paint has been applied to the surface and positioning the second patterned paint application medium on the roller prior to applying the second colored paint to the second patterned paint application medium.

16. The method of claim 7 including the step of applying a base coat to the surface of the article prior to applying the first colored patterned coating of paint on the surface.

17. The method of claim 16, wherein the base coat of paint is applied using an unpatterned paint application medium carried by a paint roller.

18. The method of claim 7, wherein the second patterned paint application medium includes a pattern having naturally occurring vegetation shapes.

19. The method of claim 18, wherein the naturally occurring vegetation shapes includes at least one of cattails, grass, leaves and bark.

20. The method of claim 7, wherein the first colored paint and the second colored paint have colors selected from the following: green, tan, olive, brown, gray, beige, black, and the like.

21. A method for applying camouflage to a surface of an article, the method comprising:
providing a split paint tray containing a first colored paint in a first portion and a second colored paint in a second portion;
applying the first colored paint and the second colored paint to a first patterned paint application medium and a second patterned paint application medium, respectively, carried by a single paint roller;
positioning the first patterned paint application medium and the second patterned paint application medium against the surface of the article and rolling the first paint application medium and the second paint application medium along the surface with a plurality of substantially nonoverlapping strokes to apply a first colored patterned coating of paint and a second colored patterned coating of paint on the surface in a side-by-side relationship;
positioning the paint roller and the first patterned paint application medium and the second patterned paint application medium against the surface and rolling the first patterned paint application medium and the second patterned paint application medium over the surface such that the first patterned paint application medium applies the first colored patterned coating of paint over the previously applied second colored patterned coating of paint and such that the second patterned paint application medium applies the second colored patterned coating of paint over the previously applied first colored patterned coating of paint.

22. The method of claim 21, wherein the first patterned paint application medium is rolled over the previously applied second colored patterned coating of paint and the second patterned paint application medium is rolled over the first colored patterned coating of paint with a plurality of substantially non-overlapping strokes.

23. A method of applying camouflage to an article, the method comprising:
positioning a patterned paint application medium loaded with a first colored paint against a surface of the article and rolling the paint application medium along the surface with a plurality of substantially non-overlapping first strokes to apply a first colored patterned coating of paint on the surface; and
positioning a patterned paint application medium loaded with a second colored paint against the surface of the article and rolling the paint application medium along the surface over the first colored pattern coating of paint with a plurality of substantially non-overlapping strokes to apply a second colored patterned coating of paint over the first colored patterned coating of paint.

24. The method of claim 23, wherein the plurality of first strokes are each in substantially a same single direction.

25. The method of claim 24, wherein the plurality of second strokes are each in substantially a same single direction.

26. The method of claim 23 including the step of allowing the first colored patterned coating of paint to dry to a slightly tacky touch before rolling the paint application medium loaded with the second colored paint along the surface.

27. The method of claim 23, wherein the second colored paint is darker than the first colored paint.

28. The method of claim 23 including the step of applying the second colored paint over the first colored paint with a second hand-held stamper trim tool.

29. The method of claim 28 including the step of removing a first patterned paint application medium from the paint roller after the first colored patterned coating of paint has been applied to the surface and positioning a second patterned paint application medium on the roller prior to applying the second colored paint to the second patterned paint application medium.

30. The method of claim 23, wherein the base coat of paint is applied using an unpatterned paint application medium carried by a paint roller.

31. The method of claim 30, wherein the second patterned paint application medium includes a pattern having naturally occurring vegetation shapes.

32. The method of claim 23, wherein the naturally occurring vegetation shapes includes at least one of cattails, grass, leaves and bark.

33. The method of claim 32, wherein the first colored paint and the second colored paint have colors selected from the following: green, tan, olive, brown, gray, beige, black, and the like.
